(19) United States
(12) Patent Application Publication
(10) Pub. No.: US 2014/0229657 A1
(43) Pub. Date: Aug. 14, 2014

(54) READDRESSING MEMORY FOR NON-VOLATILE STORAGE DEVICES

(71) Applicant: MICROSOFT CORPORATION, Redmond, WA (US)

(72) Inventors: Sergey Karamov, Redmond, WA (US); David Michael Callaghan, Redmond, WA (US)

(73) Assignee: MICROSOFT CORPORATION, Redmond, WA (US)

(21) Appl. No.: 13/763,491

(22) Filed: Feb. 8, 2013

(51) Int. Cl. G06F 12/02

(52) U.S. Cl. CPC G06F 12/0246
USPC 711/103

(57) ABSTRACT

Memory for a fragmented file on a non-volatile storage device can be readdressed to contiguous physical memory addresses, while the physical location of the file fragments of the fragmented file stored on the non-volatile storage device remain the same after the memory is readdressed. A logical block addressing (LBA) mapping table can be updated based on the readdressed contiguous physical memory addresses.

### BACKGROUND

As files get written and erased on a storage device repeatedly, over time these files may become fragmented, reducing the performance of the storage device. To help alleviate this performance issue, disk defragmentation may be performed on the storage device. Disk defragmentation refers to an operation that reduces the fragmentation of files on a storage device by moving the file fragments on the storage device to contiguous locations, thereby reducing the number of input/output (I/O) transactions between the storage device and central processing unit (CPU) memory that are required to read in or write out all of the file fragments.

Non-volatile storage devices, such as solid state drives (SSDs), have been increasingly used as storage devices in place of, or in addition to, traditional hard disk drives, such as spinning magnetic and optical drives. While defragmentation can be used effectively with traditional hard disk drives, using defragmentation with non-volatile storage devices can be problematic as these non-volatile storage devices may suffer from wear due to repeated erase operations to the device. Because non-volatile storage devices have a limited number of times they may be erased and written before their reliability is compromised, disk defragmentation of non-volatile storage devices suffers from the tradeoff of disk performance vs. life of the storage device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for rearranging memory addresses in non-volatile storage devices. For example, memory addresses can be readdressed without moving data from their physical locations on the storage device. The storage device may readdress the memory addresses in a manner transparent to the operating system. Alternatively, the operating system may issue a command to the storage device to perform optimization and to modify, e.g., a mapping table for the optimized storage device.

For example, a method can be provided for performing readdressing of memory for a fragmented file on a non-volatile storage device. The method includes sending a command to the non-volatile storage device to readdress the memory of the fragmented file, where the file fragments of the fragmented file are spread across a plurality of noncontiguous physical addresses, and receiving a response from the non-volatile storage device that the memory for the fragmented file has been readdressed to contiguous physical addresses. The physical location of the file fragments remains the same after the memory has been readdressed.

As another example, a non-volatile storage device can be configured to perform the operations described herein. For example, a non-volatile storage device can receive a command to readdress the memory of a fragmented file, and for each of the file fragments of the fragmented file, assign a contiguous physical memory address to the file fragment. The physical location of the file fragments remains the same after the memory has been readdressed.

As yet another example, a computer-readable storage medium storing computer-executable instructions can be provided for causing the system to perform operations described herein. For example, a computer-readable storage media can receive a response from a non-volatile storage device that the memory for a fragmented file has been readdressed to contiguous physical addresses, and can update a virtual mapping table based on the readdressed contiguous physical addresses. The physical location of the file fragments remains the same after the memory has been readdressed. A logical block addressing (LBA) mapping table for an operating system is not updated based on the readdressed physical addresses and the LBA mapping table communicates with the virtual mapping table.

As described herein, a variety of other features and advantages can be incorporated into the technologies as desired.

### BRIEF DESCRIPTION OF THE DRAWINGS

FIG. 1 is a block diagram of an exemplary operating environment.

FIG. 2 is a flowchart of an exemplary method for performing readdressing of memory.

FIG. 3 is a flowchart of an exemplary method for performing readdressing of memory.

FIGS. 4a, 4b, and 4c are diagrams showing examples of readdressing physical addresses.

FIGS. 5a and 5b are diagrams showing an example of readdressing physical addresses while not moving physical locations of the memory.

FIGS. 6a and 6b are tables showing an example of a mapping of the LBA mapping table and the physical addresses.

FIG. 7 is a diagram of an exemplary computing system in which some described embodiments can be implemented.

FIG. 8 is an exemplary mobile device that can be used in conjunction with the technologies described herein.

### DETAILED DESCRIPTION

### Example 1

### Exemplary Overview

The following description is directed to techniques and solutions for readdressing physical memory addresses on a non-volatile storage device. For example, physical addresses of the memory a fragmented file can be readdressed without moving the memory from their physical memory locations on the storage device.

By readdressing memory addresses, file fragments of a fragmented file may be readdressed to contiguous memory addresses allowing for more efficient file operations (e.g., retrieval of the file). For example, if the file fragments of a file are located at contiguous memory addresses, the operating system may be able to make a single request or pack multiple requests to the non-volatile storage device to retrieve the file. On the other hand, if the file is located at noncontiguous memory addresses, the operating system may have to make multiple requests to the storage device to retrieve the file.

Disk defragmentation of the non-volatile storage device would potentially achieve a similar effect. By defragmenting the storage device, the file fragments would be moved between actual physical memory locations on the storage device such that the file fragments would be located at contiguous physical memory locations after the defragmentation. However, defragmentation may shorten the useful life of a non-volatile storage device, such as an SSD, since each defragmentation operation would require multiple erase and write operations to move the file fragments around in the storage device, increasing wear on the storage device. The problem of additional wear is larger than just erasing and writing the data due to a phenomenon known in the industry as write amplification. Write amplification describes a scenario where memory must be erased before it is rewritten to. Data is typically written in page sizes of, for example, 4-8 kilobytes in size, whereas a block to be erased (erase block) is typically much larger in size (for example, 128 kilobytes or even several MB on some high density storage devices). Therefore, when writing or moving data, even if, for example, 512 bytes of data are to be written, this write may result in having to move and erase a much larger block of data. It should be appreciated that defragmenting these drives, when unaware of the underlying implications, can shorten the time the storage devices can reliably operate, and that the embodiments described herein can extend the time that the storage device can reliably operate while still periodically removing the fragmentation.

Defragmentation with spinning magnetic and optical drives require that file fragments are physically moved to new adjacent locations on the drive to achieve optimizations in the I/O pipeline that occur when the read-and-write head is in the physical vicinity of other file fragments. The embodiments described herein will show how an operating system can leverage non-volatile storage devices to optimize I/O patterns by modifying the addressable locations where the content is stored without having to actually copy the content to new physically adjacent locations. The non-volatile storage devices store content at an addressable location that can be optimized by modifying the lookup address of disparate locations where related content is stored to be logically adjacent. The embodiments described herein further provide similar I/O performance advantages to defragmentation without incurring the damaging effects of premature wear on the storage device, and avoids expending electrical power and end user impact associated with rearranging significant amounts of the storage system content instead of end-user tasks, such as saving a photo or playing a movie.

### Example 2

### Exemplary Non-Volatile Storage Devices

As used herein, a non-volatile storage device refers to any semiconductor-based storage device that retains its information without requiring to be powered on. For example, a non-volatile storage device can be a solid state drive, a USB flash drive, embedded memory on a chip, phase change memory device, or any other type of non-volatile semiconductor-based storage. The embodiments described herein can also be used in any scenario where ordered information can become distributed due to fragmentation, such as Random Access Memory (RAM), using the mechanisms described herein to reorder the blocks into a sequential layout through block or page readdressing without having to actually copy the data to different storage pages.

As used herein, non-volatile memory refers to semiconductor-based storage, and therefore does not include magnetic storage devices (e.g., hard disk drives) or optical storage devices (e.g., CD or DVD media).

### Example 3

### Readdressing Physical Memory

As opposed to magnetic or optical storage devices, non-volatile storage devices do not read data linearly. For example, in a magnetic storage device, a read-and-write head moves to a location on a platter and, as the platter spins, reads the information from that platter. If the magnetic storage device wants to read data at another location on the platter, the read-and-write head must move to the new location. The physical addresses of a magnetic storage device are arranged based on the locations on the platter(s).

On the other hand, non-volatile storage devices do not use read-and-write heads, and instead, can read information by determining the state of individual transistors. As a voltage is flowed through the transistors, the current flow is detected as binary data. This operation can be performed at many different transistors in parallel. Although these devices do not suffer from the latency associated with moving a physical read/write head to a specific location, they do demonstrate performance benefits when the operating system and applications make fewer but larger accesses to retrieve or store data than when using many smaller transactions. For example, it is better from a performance and power consumption perspective to read a 1 MB chunk that maps to one contiguous sequential file read request than it is to perform 2,000 accesses of 512 bytes each to retrieve the same file payload. Systems employing the embodiments described herein can deliver high write speeds by dumping the data to a disparate set of blocks instead of freeing up contiguous blocks because the data ends up being addressed as if it was actually located in physically adjacent addressable blocks.

However, computing devices using non-volatile storage devices, and the storage devices themselves, usually treat the non-volatile storage device in a similar manner as magnetic storage devices, i.e., as if it must be read in a linear fashion. A flash translation layer (FTL) allows the data to appear to be in specific physical locations and the FTL keeps track of the mapping of physical memory addresses to physical locations on the non-volatile storage device. Thus, the non-volatile storage device assigns physical addresses to transistor locations so that they can appear to be read linearly.

However, there is no common mapping scheme for physical addresses and physical locations of particular transistors in the storage device, i.e., a physical address can map to any location on the storage device and nearby physical addresses do not have to map to nearby physical locations, and instead each semiconductor storage device manufacturer may come up with their own scheme to assign physical memory addresses to the storage device. For example, some manufacturers may hard-code the physical memory addresses in the storage device, while others may dynamically assign memory addresses for, e.g., wear leveling.

### Example 4

### Exemplary Operating Environment

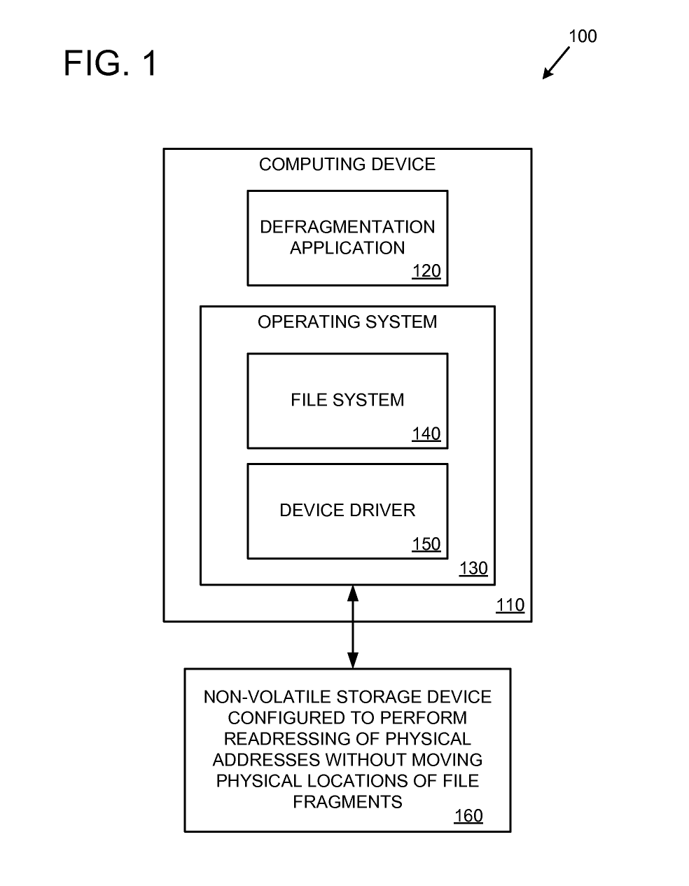

In any of the examples herein, an operating environment 100 can be provided for readdressing memory addresses. FIG. 1 is a diagram depicting an exemplary operating environment 100. The exemplary operating environment 100 includes a computing device 110 that comprises a defragmentation application 120 and an operating system 130. For example, the computing device 110 may be a mobile computing device, such as a mobile phone or tablet computer.

The operating system 130 is in communication with a non-volatile storage device 160. The operating system 130 includes a file system 140 and device drivers 150. File system 140 maintains the location of files on the non-volatile storage device 160 and manages access to the non-volatile storage device 160. For example, the file system 140 may be NTFS (New Technology File System), a file system developed by Microsoft Corporation for its Windows operating system. Device driver 150 controls the non-volatile storage device and handles communication between the operating system 130 and the non-volatile storage device 160.

In FIG. 1, the computing device 110 and non-volatile storage device 160 are shown as separate components for illustrative purposes. However, it is understood that the computing device 110 and non-volatile storage device 160 may be the same device.

In FIG. 1, the operating system 130 contains the file system 140 and device driver 150 to communicate with the non-volatile storage device 160. However, the operating system 130 may contain other components that communicate with the non-volatile storage device 160. In one embodiment, the command to readdress the memory may come from one of these other operating system components.

In an example, the computing device 110 may contain a defragmentation application 120. Although the defragmentation application 120 is shown as being outside the operating system 130 in FIG. 1, it should be appreciated the defragmentation application 120 may be modified such that it is integrated into the file system 140, or included in the device driver 150. Further, in some embodiments the defragmentation may be integrated into the non-volatile storage device 160 itself.

When the defragmentation application 120 is executed on the computing device 110, it may command the non-volatile storage device 160 to readdress memory addresses to accomplish readdressing of the storage device. The defragmentation application 120 can examine how each file stored in the file system 140 is mapped through the device driver 150 to the storage addresses in the non-volatile storage device 160. When the defragmentation application 120 determines a file is stored across more than a configurable or predefined number of fragments (1, 2, 20, etc.), it can invoke a readdressing approach. In other embodiments the defragmentation application 120 can use criteria such as frequently accessed files, or any number of other heuristics such as file sizes, system files, user files, etc. The defragmentation application 120 can issue a command through the file system 140 and device driver 150 with the file address locations which are fragmented to the storage device 160, and receive back a response with the new non-fragmented (or lesser fragmented) address location(s). For example, if a file is discovered to be distributed across 15 noncontiguous storage addresses, after the readdressing the file system views it as 15 contiguous storage address locations. The file system 140 can then perform a sequential access to read or write to the file which is much faster than 15 discrete transactions to retrieve and assemble each fragment. The embodiments described herein describe how the storage device 160 accomplishes the readdressing without copying the file fragments to available free storage, and instead simply readdresses the storage blocks into a contiguous addressable range so that the device driver 150 and file system 140 operate in a more efficient transfer mode. In other embodiments, the defragmentation application 120 can, through the file system 140 and device driver 150, simply command the storage device 160 that a file should be made consecutive using the supplied list of file storage addresses. If the command receives a success response then the file system knows that it should use the new address location(s), whereas if it receives an error response it can retry the readdressing at a later time.

Alternatively, the defragmentation application 120 may exist in the non-volatile storage device 160 and the operating system 130 may command the non-volatile storage device 160 to run the defragmentation application 120 periodically, and the non-volatile storage device 160 may instead perform readdressing of memory on the storage device 160 itself. In this example, the storage device 160 is provided information by the file system 140, such as the list of files and the fragment locations where they are stored. After the non-volatile storage device 160 completes the readdressing it may respond with the information describing the new locations of the file contents and uploads the changes to the device driver 150 and file system 140. The file system 140 would then use the new addresses for the file fragments at the readdressed locations when reading and writing the file blocks.

In an example, the device driver 150 may contain the defragmentation application 120 or a defragmentation application 120 outside the device driver may call a routine to defragment or readdress the non-volatile storage device 160. Alternatively, the device driver 150 may have its own defragmentation application 120 to start the readdressing operation as well as communicate with special protocol commands used to readdress the storage locations over the bus communicatively coupling the storage device 160 to the computing device 110.

### Example 5

### Method for Performing Readdressing

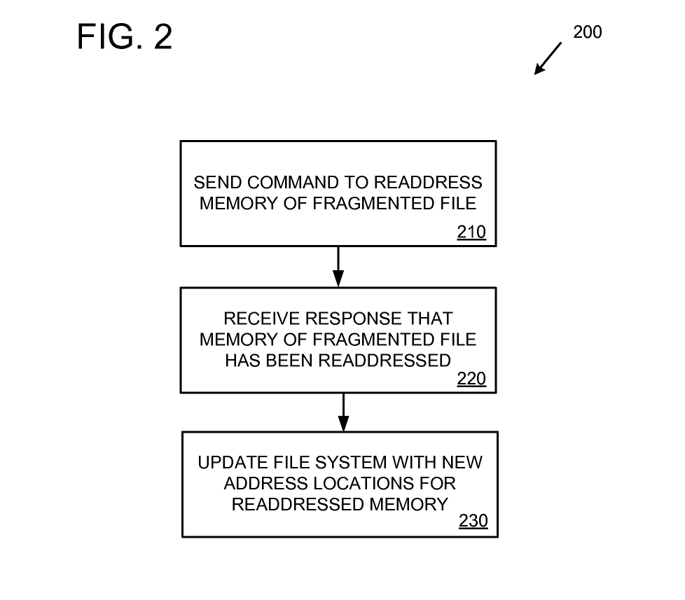

FIG. 2 is a flowchart of an exemplary method 200 for performing readdressing of memory for a fragmented file on the non-volatile storage device 160.

At 210, a command is sent to the non-volatile storage device 160 to readdress memory for the fragmented file.

The goal of the readdressing command 210 is to convert a file distributed across several non-consecutively addressed storage blocks which essentially appears as a random I/O access pattern to the non-volatile storage device 160 into fewer (e.g., one) sequential accesses. The embodiments described herein accomplish readdressing the storage locations without having to physically copy the data to new storage locations, which results in using up more power than readdressing, negatively impacting the storage lifespan, and introducing significantly more lengthy I/O cycles copying storage content to the operating system and back to the storage part with the goal of defragmenting the files, which can get in the way of tasks associated with applications the end user wants to run or the normal operating system behaviors.

At 220, a response is received from the non-volatile storage device 160 that the memory for the fragmented file has been readdressed.

At 230, the file system 140 will update its internal record keeping where the file fragments are addressed. In some embodiments, the file system 140 may update its records when the command is sent at 210 and roll back the readdressing transaction if it does not receive a successful response at 220. In other embodiments, the file system 140 may wait until it receives a response to commit or make the corresponding readdressing changes based upon the new address blocks returned in response 220. For example, the response 220 can contain the new mappings for the blocks requested to be readdressed in command 210, and the final agreed upon addressing for the blocks is complete when the file system 140 is updated at 230.

In an example, after the file system 140 is updated, the computing device 110 may perform operations reflecting the now readdressed memory.

In an example, the computing device can send a further command to the non-volatile storage device 160 using the now readdressed memory comprising contiguous physical addresses. For example, the computing device can send a single request or a pack of multiple requests to retrieve the file at the contiguous physical addresses. Since the file is located at contiguous physical addresses, the number of operations for the computing device is reduced. The internal caching mechanisms used by the non-volatile storage device 160 can be more efficiently utilized since the storage request after readdressing can be implemented as a contiguous sequential request for data. The performance benefits inherent to larger sequential reads and writes over smaller random read and writes is well documented by the performance benchmarks of modern storage devices such as SD cards, eMMC devices, MMC, and SSD drives.

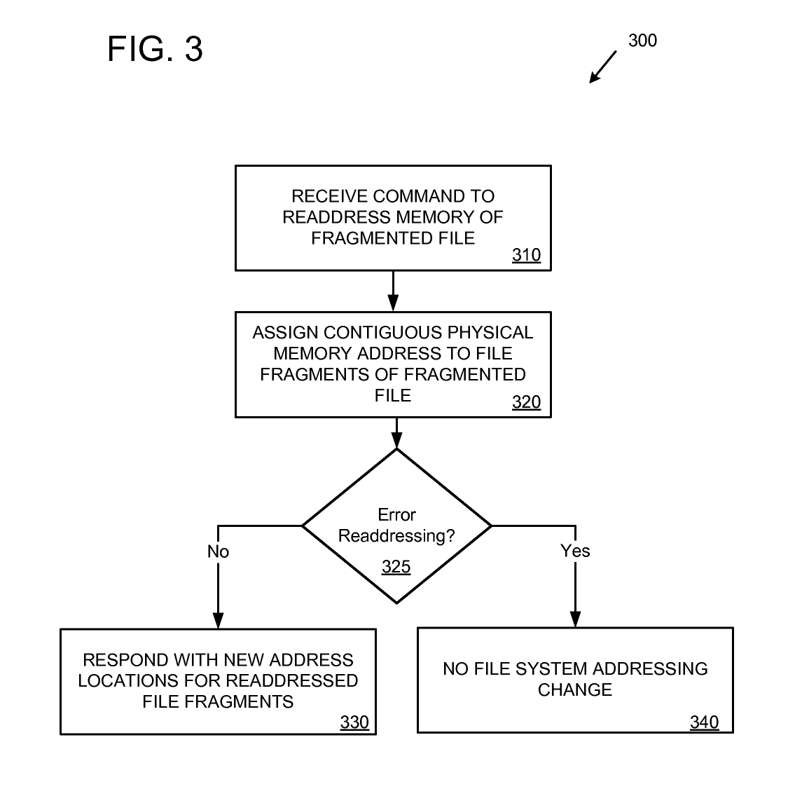

FIG. 3 is a flowchart of an exemplary method 300 for performing readdressing of memory for a fragmented file on the non-volatile storage device 160. The steps shown in FIG. 3 correspond to those shown in FIG. 2. At 310, a command to readdress the memory of a fragmented file is received.

At 320, contiguous physical memory addresses are assigned to the memory of the fragmented file. That is, each of the file fragments previously located at a plurality of noncontiguous physical memory addresses are readdressed to contiguous physical memory addresses.

At 325, the non-volatile storage device 160 may return an error processing the readdress change and the system will flow to 340, at which is no readdressing changes are made and the readdressing is aborted. If the readdressing is successful the system will flow to 330. If the non-volatile storage device 160 cannot complete the command, the operating system 130 may receive an error as part of the file system 140 not readdressing, as shown by 340.

At 330, the non-volatile storage device 160 can respond to the operating system 130 (which includes the device driver 150 and file system 140) with the new address locations for the file fragments. In some embodiments, the computing device 110 may not need to perform step 330 to respond to the operating system 130 because the non-volatile storage device 160 simply completes the command. In other embodiments, the response may only need to be a success response that the blocks have been readdressed.

In some embodiments, the readdressing logic can be included as part of the operating system 130 which keeps track of all the blocks and available blocks that can be modified to make the readdressing defragmented. In other embodiments, the operating system can request that the non-volatile storage device 160 manage the blocks and simply ask that a file it knows is very fragmented be readdressed, and expects a response that contains the new block mappings.

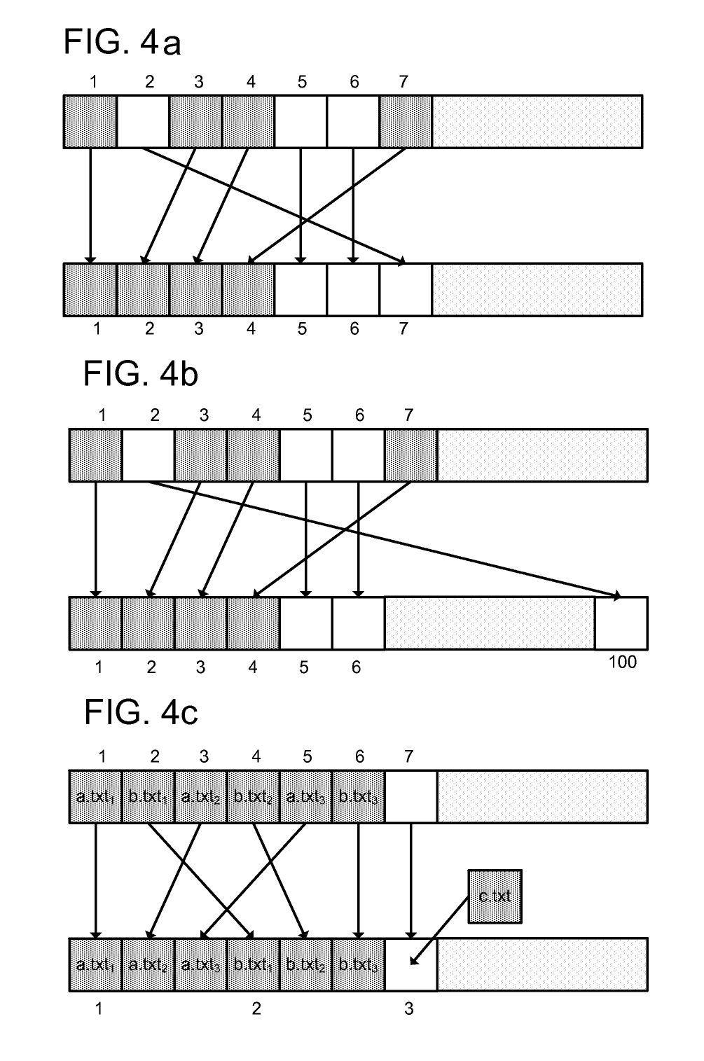

Lastly in some embodiments the readdressing will keep the original starting block address for the file, and the readdressing will make all subsequent storage blocks addressed after the start address consecutive so they appear to be a sequential access; however, the subsequent blocks may not actually have unique addresses compared to addresses that can be computed as belonging to other files. This will be described in detail later in FIG. 4c as a readdressing solution which incorporates sparse addressing when blocks contained by two files appear to overlap blocks to an external observer.

In an example implementation with regard to FIG. 1, the non-volatile storage device 160 may send a response 330 that the memory of the fragmented file has been readdressed, but it is not necessary for a response to be sent back. For example, the non-volatile storage device 160 may only receive the command to readdress the fragmented file and the operating system 130, file system 140, device driver 150 or defragmentation application 120 will assume it has completed successfully if the non-volatile storage device 160 is operating normally.

For example, with reference to FIG. 1, the command to readdress memory may come from the file system 140, device driver 150, or the non-volatile storage device 160. In an embodiment, there may be another operating system component in the computing device 110 that provides the command to the non-volatile storage device 160. In another embodiment, a separate component may exist between the operating system 130 and the non-volatile memory that provides the command to the non-volatile storage device 160. The defragmentation application 120 may be present in one or more of the computing device 110, operating system 130, file system 140, and device driver 150. The selection of where the defragmentation originates is left up to the designer of the system, who may choose which application model to deploy based upon how the various vendors implement the quality and cost of the readdressing solution.

In an example implementation with regard to FIG. 1, the command to readdress memory is received by the non-volatile storage device 160. However, the command may not specify which fragmented files need to be readdressed. For example, the command may be part of a defragmentation request to the non-volatile storage device 160. In this case, the non-volatile storage device 160 may determine a most likely candidate file to readdress based on the degree of fragmentation of the files and select that file to readdress. However, the fragmented file to be readdressed need not be the most fragmented file. For example, the non-volatile storage device 160 may determine a most likely candidate file based on frequency of access by the operating system of the file, location of the physical memory addresses of the file, or any other criteria. The non-volatile storage device 160 can be provided a list of all the files with fragments by the file system 140 or as tracked by the device driver 150 or operating system 130 or even the defragmentation application 120.

The non-volatile storage device 160 may perform readdressing using any of the methods disclosed herein, but is not limited to those methods. Any method that readdresses memory for a fragmented file on a non-volatile storage device may be performed.

### Example 6

### Exemplary Virtual Mapping

FIGS. 4a and 4b are diagrams showing an example of readdressing physical memory addresses. In the example, the file fragments of a fragmented file are spread across a plurality of noncontiguous physical addresses. For example, assume that a fragmented file is located at memory addresses 1, 3, 4 and 7. Once the storage device receives a command to readdress the fragmented file to contiguous physical memory addresses, the storage device determines at which physical memory addresses the file is to be readdressed. In this example, the file is readdressed starting at memory address 1, but may instead be readdressed starting at any physical memory address.

In this example, old memory address 3 is readdressed to new memory address 2. However, old memory address 2 may contain other data. Thus, the memory addresses are swapped, i.e., old memory address 3 is readdressed to new memory address 2 and old memory address 2 is readdressed to new memory address 3. This is repeated for all of the remaining memory addresses of the fragmented file. The end result is that old memory addresses 3, 4 and 7 are readdressed to new memory addresses 2, 3 and 4, allowing the memory of the fragmented file to now be addressed at contiguous physical memory addresses, and old memory address 2 is readdressed to new memory address 7. In scenarios where the cluster or sector size managed by the file system 140 is a close 1:1 relationship to the block sizes in the storage device 160, the implementation is very much like that which is shown by FIG. 4a. It should be appreciated that the sector sizes and cluster sizes managed by the file system 140 do not have to be a 1:1 relationship for the basic principles of readdressing the storage locations without actually copying the data to perform defragmentation with less copying and writing of the data as compared to the defragmentation solution already in practice.

However, the physical memory addresses do not necessarily need to be swapped, and instead can be readdressed to unused memory addresses. For example, in FIG. 4b, old memory address 2 may be readdressed to available memory address 100 (e.g., an available memory address that is empty). The other memory addresses of the fragmented file are then able to be readdressed to contiguous physical addresses.

FIG. 4c describes an alternative embodiment of the readdressing mechanism that keeps the original unique starting block address for the file. In this embodiment, the readdressing makes all subsequent storage blocks addressed after the start address consecutive so they appear to be a sequential access to the file system 140 or the operating system 130; however, the second and subsequent blocks may not actually have unique addresses compared to the addresses which can be computed as belonging to other files (e.g., the second and subsequent blocks can have shareable physical memory addresses). Since the file is only retrieved using the unique starting address and a specific length of blocks, and since it is always a sequential access, the stream of content following the initial unique block address may be non-ambiguously addressed. For example in FIG. 4c, the top set of blocks show the state before the readdressing; and show a file “a.txt” that starts at block 1 and contains additional fragments at blocks 3 and 5 for a total length of 3 blocks (as shown by fragments a.txt₁, a.txt₂, a.txt₃, respectively). The system may also have a file “b.txt,” which starts at block 2 and has content stored as fragments in blocks 4 and 6 (as shown as b.txt₁, b.txt₂, b.txt₃, respectively). The readdressing command for file “a.txt” can be sent by the file system 140 and command a readdressing for a file at blocks 1, 3, 5 to become sequential, i.e., starting at block 1 for a length of 3 blocks. This readdressing would leave the content at block 1 unchanged, but then readdress block 3 as block 2 (only when it follows a block 1 read) and readdress block 5 as block 3 only when it follows a read of blocks 1 and 2. Therefore, after readdressing the file “a.txt” is stored in blocks 1, 2, and 3 when sequentially accessed from an external source (as shown on the bottom half of FIG. 4c). The non-volatile storage device 160 would report an error if the file system 140 were to attempt to read block 2 or 3 for a single length block since it knows that the system must only retrieve the file by reading block 1 and optionally blocks 2 and 3 thereafter as part of a single sequential access. The contents are uniquely provide to the file system 140 and storage driver 150 provided they are sequentially addressed using a command starting at block 1 with a length of 3. The file system 140 also commands that file “b.txt” starting at block 2 and containing blocks 4 and 6 be readdressed assuming it will become blocks 2, 3, 4 using a similar mechanism as shown in FIG. 4c. An external observer such as the file system 140, may compute that the starting addresses and length of “a.txt” and “b.txt” both share content in blocks 2 and 3 and therefore the content is occupying the same storage blocks. However, this may not be the case because the non-volatile storage device 160 understands that since the access to “a.txt” and “b.txt” are always sequential accesses starting at unique addresses, the storage part will deliver unique content mapped to only file “a.txt” when it receives a 3 block long access starting at block 1, and it will only retrieve contents for file “b.txt” when it receives a 3 block long request starting at block 2. The non-volatile storage device 160 will not provide the block address 1 or 2 to any other files, and in some embodiments the file system 140 knows only to access files using the staring address, not to seek into the file and access blocks which are overlapping. Also, in some embodiments, the file system 140 will not receive a starting storage block that has a starting address of block 3, 4, 5 or 6 because these blocks are actually in use by the files “a.txt” and “b.txt.” Alternative embodiments may provide starting addresses of block 3, 4, 5 or 6; however, the total address blocks provided to the file system 140 will not exceed the storage capacity of the non-volatile storage device 160. Further, FIG. 4c shows that the free block 7 is readdressed to provide an available starting block address of 3. Assuming the file system 140 were to store a new file “c.txt” as a 1 block write to address 3, then it would expect to receive file “b.txt” contents when it reads a 3 block access starting at address 2, and expect to obtain “c.txt” content when it issues a single block read starting at address 3. In some embodiments, this type of readdressing would only be performed on files that are read in a sequential manner. In some embodiments, the file system 140 can set attributes to not seek these kinds of files that are readdressed in this manner.

It should be appreciated that the examples of FIGS. 4a-4c all show a 1:1 mapping between the discrete units of storage for file fragments tracked by the file system 140 (i.e., clusters) and storage blocks (discrete units of storage provided by the non-volatile storage device 160, i.e., blocks or sectors); however, for the embodiments described herein, it could easily be shown that the file fragments occupy a sub portion of the storage block as well as the file fragments stored in each cluster map across several addressable storage blocks. That is to say a file fragment (cluster) and storage block (sector) ratio could be 1:1, 2:1, 1:2, 1:16, 16:1, etc. The readdressing principles are simply extended to ensure that a unique address is provided for the storage with minimal copies of data being made during the readdress processing when a partial page needs to be moved. And the storage space consumed by files “a.txt” and “b.txt” before and after the readdress would remain constant and consume 6 blocks of the non-volatile storage device 160.

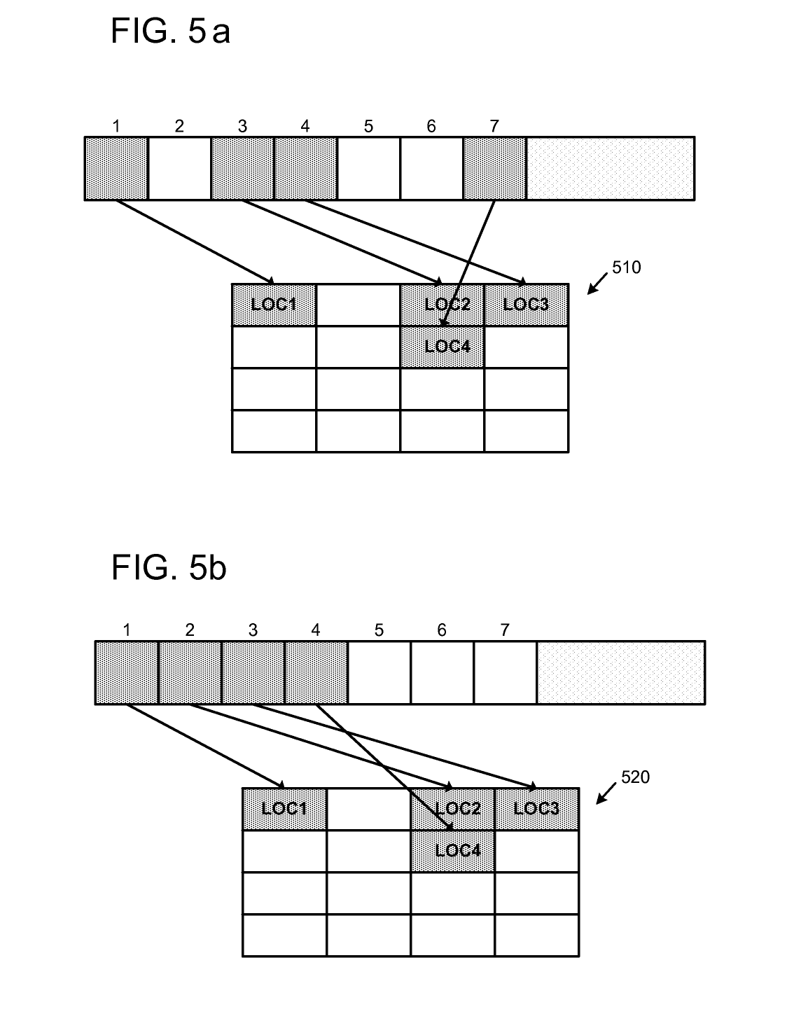

The readdressing of physical memory addresses is performed (e.g., as described above with reference to FIGS. 4a and 4b) without moving physical locations of the memory in the non-volatile storage device 160. FIGS. 5a and 5b are diagrams showing how the readdressing operations described in FIGS. 4a and 4b are performed without moving physical locations of the memory. Taking the previous example, old memory addresses 1, 3, 4 and 7 are readdressed to new memory addresses 1, 2, 3 and 4. However, the actual physical locations of the file fragments of the fragmented file on the memory device are not moved. With reference to the example, FIG. 5a depicts memory addresses 1, 3, 4, and 7 before readdressing. As depicted in FIG. 5a, the non-volatile storage device 160 stores the file fragments corresponding to memory addresses 1, 3, 4, and 7 at particular physical locations within the non-volatile storage device 160, which are depicted in simplified form at 510 as “LOC1” through “LOC4.” FIG. 5b depicts the memory addresses after the memory readdressing has been performed. As depicted at in FIG. 5b, readdressing has been performed such that the memory addresses are now contiguous (addresses 1, 2, 3, 4). Also, as depicted in FIG. 5b, even though readdressing has been performed, the physical locations of the memory in the non-volatile storage device 160 have not changed. Thus, for example, although old memory address 3 was readdressed to new memory address 2, the physical location of the memory has not changed.

In some embodiments the software and/or hardware which perform this address translation and supporting the remapping can be stored inside the non-volatile storage device 160. In other embodiments the remapping can be a distributed solution across the file system 140, storage driver 150, and the non-volatile storage device 160. For example, the file system 140 may keep track of the mapping of logical to physical blocks and submit a remapping solution to the non-volatile storage device 160, which applies this change. In other embodiments, the storage driver can perform the translation between the addresses it knows the file system 140 has mapped to the storage blocks in storage device 160 and therefore provides the storage device a remapping without the file system 140 being aware of the remapping.

### Example 7

### Exemplary Mapping Table

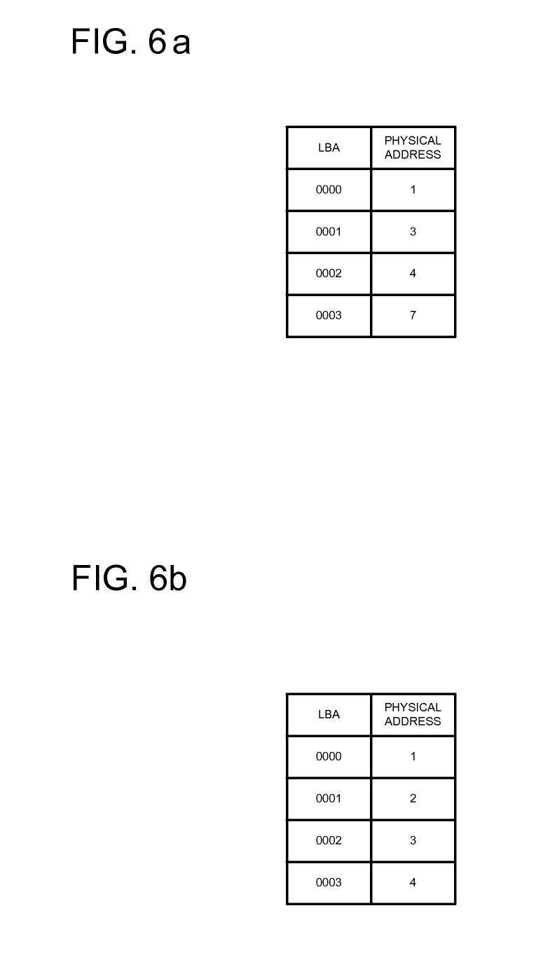

FIGS. 6a and 6b are tables showing an example of a mapping of the LBA mapping table and the physical addresses of the fragmented file in FIGS. 4a and 4b. For example, the LBA mapping table can be used by the operating system 130 to assign logical addresses to the physical addresses on the non-volatile storage device 160. Since, in the previous example, the physical addresses have been readdressed, the LBA mapping table is updated based on the readdressed memory. Thus, for example, in FIG. 6a, LBA 0000 points to physical address 1, LBA 0001 points to physical address 3, LBA 0002 points to physical address 4, and LBA 0003 points to physical address 7. After the readdressing, as shown in FIG. 6b, LBA 0000 points to physical address 1, LBA 0001 points to physical address 2, LBA 0002 points to physical address 3, and LBA 0003 points to physical address 4.

As shown in FIGS. 6a and 6b, the LBA mapping table may be updated to reflect the readdressing of the memory. However, the LBA mapping table does not necessarily need to be updated. For example, a virtual mapping table may exist between the LBA mapping table and the storage device. The virtual mapping table may be updated with the new information of the readdressing of the memory. When the LBA mapping table looks for an address, the updated virtual mapping table may point to the readdressed physical addresses, without the LBA mapping table being aware that such readdressing has occurred. In this case, the LBA mapping table communicates with the virtual mapping table that contains the information for the readdressed physical memory addresses.

### Example 8

### Exemplary Computing Environment

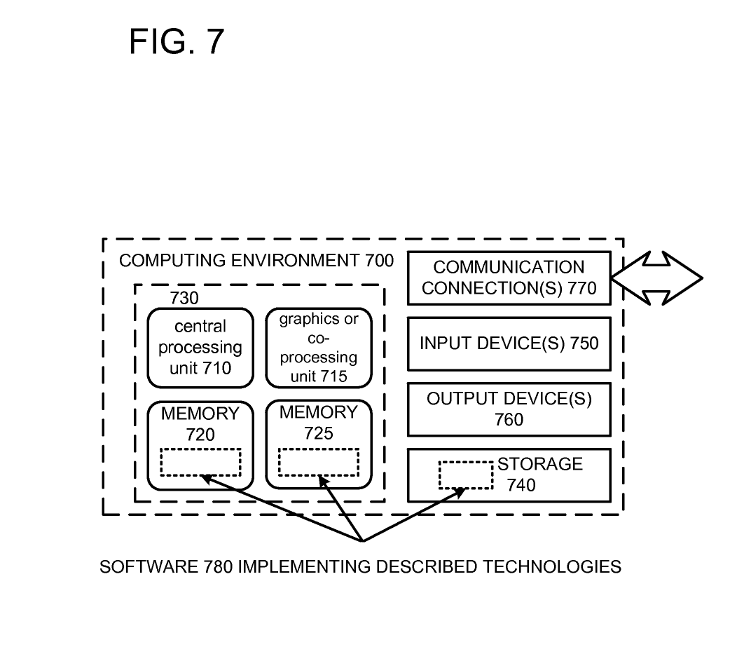

FIG. 7 depicts a generalized example of a suitable computing environment 700 in which the described innovations may be implemented. The computing environment 700 is not intended to suggest any limitation as to scope of use or functionality, as the innovations may be implemented in diverse general-purpose or special-purpose computing systems. For example, the computing environment 700 can be any of a variety of computing devices (e.g., desktop computer, laptop computer, server computer, tablet computer, media player, gaming system, mobile device, etc.).

With reference to FIG. 7, the computing environment 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s).

A computing system may have additional features. For example, the computing environment 700 includes storage 740, one or more input devices 750, one or more output devices 760, and one or more communication connections 770. An interconnection mechanism (not shown) such as a bus, controller, or network interconnects the components of the computing environment 700. Typically, operating system software (not shown) provides an operating environment for other software executing in the computing environment 700, and coordinates activities of the components of the computing environment 700.

The tangible storage 740 may be removable or non-removable, and includes magnetic disks, magnetic tapes or cassettes, CD-ROMs, DVDs, or any other medium which can be used to store information in a non-transitory way and which can be accessed within the computing environment 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing environment 700. For video encoding, the input device(s) 750 may be a camera, video card, TV tuner card, or similar device that accepts video input in analog or digital form, or a CD-ROM or CD-RW that reads video samples into the computing environment 700. The output device(s) 760 may be a display, printer, speaker, CD-writer, or another device that provides output from the computing environment 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

### Example 9

### Exemplary Mobile Device

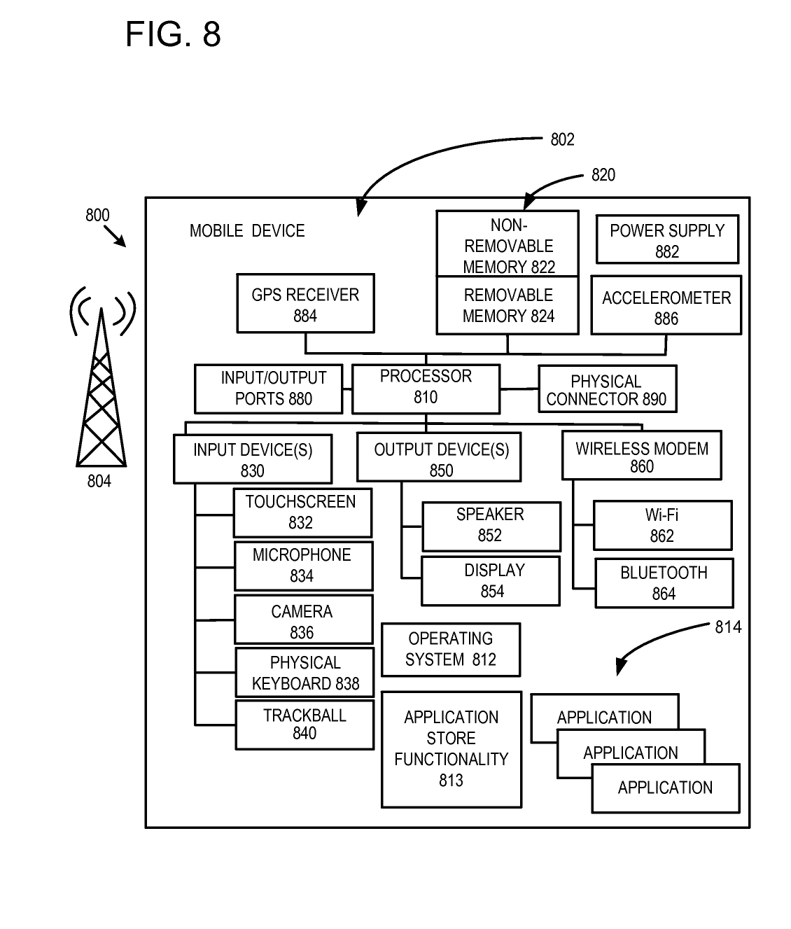

FIG. 8 is a system diagram depicting an exemplary mobile device 800 including a variety of optional hardware and software components, shown generally at 802. Any components 802 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 804, such as a cellular, satellite, or other network.

The illustrated mobile device 800 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components 802 and support for one or more applications 814. The applications 814 can include common mobile computing applications (e.g., email applications, calendars, contact managers, web browsers, messaging applications), or any other computing application. Functionality 813 for accessing an application store can also be used for acquiring and updating applications 814.

The illustrated mobile device 800 can include memory 820. Memory 820 can include non-removable memory 822 and/or removable memory 824. The non-removable memory 822 can include RAM, ROM, flash memory, a hard disk, or other well-known memory storage technologies. The removable memory 824 can include flash memory or a Subscriber Identity Module (SIM) card, which is well known in GSM communication systems, or other well-known memory storage technologies, such as “smart cards.” The memory 820 can be used for storing data and/or code for running the operating system 812 and the applications 814. Example data can include web pages, text, images, sound files, video data, or other data sets to be sent to and/or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 800 can support one or more input devices 830, such as a touchscreen 832, microphone 834, camera 836, physical keyboard 838 and/or trackball 840 and one or more output devices 850, such as a speaker 852 and a display 854. Other possible output devices (not shown) can include piezoelectric or other haptic output devices. Some devices can serve more than one input/output function. For example, touchscreen 832 and display 854 can be combined in a single input/output device.

The input devices 830 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 812 or applications 814 can comprise speech-recognition software as part of a voice user interface that allows a user to operate the device 800 via voice commands. Further, the device 800 can comprise input devices and software that allows for user interaction via a user's spatial gestures, such as detecting and interpreting gestures to provide input to a gaming application.

A wireless modem 860 can be coupled to an antenna (not shown) and can support two-way communications between the processor 810 and external devices, as is well understood in the art. The modem 860 is shown generically and can include a cellular modem for communicating with the mobile communication network 804 and/or other radio-based modems (e.g., Bluetooth 864 or Wi-Fi 862). The wireless modem 860 is typically configured for communication with one or more cellular networks, such as a GSM network for data and voice communications within a single cellular network, between cellular networks, or between the mobile device and a public switched telephone network (PSTN).

The mobile device can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components 802 are not required or all-inclusive, as any components can be deleted and other components can be added.

### Example 10

### Exemplary Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media and executed on a computing device (e.g., any available computing device, including smart phones or other mobile devices that include computing hardware). Computer-readable storage media are any available tangible media that can be accessed within a computing environment (e.g., non-transitory computer-readable media, such as one or more optical media discs, volatile memory components (such as DRAM or SRAM), or non-volatile memory components (such as flash memory or hard drives)). By way of example and with reference to FIG. 7, computer-readable storage media include memory 720 and 725, and storage 740. By way of example and with reference to FIG. 8, computer-readable storage media include memory 820, 822, and 824. The term computer-readable storage media does not include communication connections (e.g., 770, 860, 862, and 864) such as signals and carrier waves.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

### ALTERNATIVES

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope of these claims.

We claim:

1. A method, performed at least in part by a computing device, for performing readdressing of memory for a fragmented file on a non-volatile storage device, comprising:
sending, by the computing device, a command to the non-volatile storage device to readdress the memory of the fragmented file, wherein file fragments of the fragmented file are spread across a plurality of noncontiguous physical addresses and are stored at a plurality of physical locations within the non-volatile storage device; and
receiving, by the computing device, a response from the non-volatile storage device that the memory of the fragmented file has been readdressed, wherein the memory has been readdressed to contiguous physical addresses;
wherein the plurality of physical locations of the file fragments remains the same after the memory of the fragmented file has been readdressed.

2. The method of claim 1, further comprising updating a logical block addressing (LBA) mapping table based on the readdressed memory.

3. The method of claim 1, further comprising:
sending, by the computing device, an optimized command to read the fragmented file using the contiguous physical addresses.

4. The method of claim 3, wherein the optimized command is a single request.

5. The method of claim 3, wherein the optimized command is a packed request.

6. The method of claim 1, wherein the non-volatile storage device is a solid state drive.

7. The method of claim 1, wherein the non-volatile storage device is a phase change memory device.

8. The method of claim 1, wherein the command to readdress the memory of the fragmented file is part of an automated maintenance schedule of the non-volatile storage device.

9. The method of claim 1, wherein the command to readdress the memory of the fragmented file is sent from an operating system component of the computing device.

10. A non-volatile storage device comprising:
a processing unit; and
non-volatile memory;
the non-volatile storage device configured to perform operations for readdressing memory for a fragmented file, the operations comprising:
receiving a command to readdress the memory of the fragmented file, wherein file fragments of the fragmented file are spread across a plurality of noncontiguous physical addresses and are stored at a plurality of physical locations within the non-volatile storage device; and
for each of the file fragments, assigning a contiguous physical memory address to the file fragment;
wherein the plurality of physical locations of the file fragments remains the same after the memory of the fragmented file has been readdressed.

11. The non-volatile storage device of claim 10, wherein the non-volatile storage device is a solid state drive.

12. The non-volatile storage device of claim 10, wherein the non-volatile storage device is a phase change memory device.

13. The non-volatile storage device of claim 10, wherein for each of the file fragments, if other data is located at a physical memory address to which the file fragment is to be assigned, assigning a new memory address to the other data.

14. The non-volatile storage device of claim 13, wherein the assigning the new memory address to the other data comprises swapping the physical memory address of the other data with a memory address of the file fragment.

15. The non-volatile storage device of claim 13, wherein the assigning the new memory address to the other data comprises assigning an unused memory address to the other data.

16. The non-volatile storage device of claim 10, wherein the assigning the contiguous physical memory address to the file fragment comprises:
for a starting block of the fragmented file, assigning a unique physical memory address; and
for one or more subsequent blocks of the fragmented file, assigning shareable physical memory addresses.

17. The non-volatile storage device of claim 10, wherein the command to readdress the memory of the fragmented file is received as part of an automated maintenance schedule of the non-volatile storage device.

18. The non-volatile storage device of claim 10, wherein the command to readdress the memory of the fragmented file is received from an operating system component.

19. The non-volatile storage device of claim 10, wherein the receiving a command to readdress the memory of the fragmented file comprises:
determining a most likely candidate file to readdress based on degree of fragmentation; and
selecting the most likely candidate file as the fragmented file.

20. A computer-readable storage medium storing computer-executable instructions for causing a computing device to perform operations for readdressing memory for a fragmented file, the operations comprising:
receiving a response from a non-volatile storage device that the memory of the fragmented file has been readdressed, wherein the memory has been readdressed to contiguous physical addresses; and
updating a virtual mapping table based on the readdressed contiguous physical addresses;
wherein physical locations of file fragments of the fragmented file remain the same after the memory of the fragmented file has been readdressed;
wherein a logical block addressing (LBA) mapping table for an operating system is not updated based on the readdressed contiguous physical addresses; and
wherein the LBA mapping table communicates with the virtual mapping table.
